(19) United States
(12) Patent Application Publication
(10) Pub. No.: US 2006/0293077 A1
(43) Pub. Date: Dec. 28, 2006

(54) System, terminal, method, and computer program product for allocating memory for storage of content

(75) Inventors: Janne La Aaltonen, Turku (FI); Petri Hyysalo, Espoo (FI); Arto Kiiskinen, Espoo (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/167,405

(22) Filed: Jun. 27, 2005

(51) Int. Cl. H04M 1/00

(52) U.S. Cl. 455/551

(57) ABSTRACT

A terminal, system, method, and computer program product are provided that are capable of allocating memory for content storage in the terminal. Content may be stored as either fixed or replaceable content. Storing some content as replaceable content enables a service provider to take advantage of favorable network connections to download content that is not to be viewed by the user until a later date, while not preventing the user from being able to store other content if desired. While replaceable content may be stored in the storage element in the terminal, the replaceable content typically does not reserve memory space. As such, other content items may overwrite the replaceable content if necessary due to insufficient open memory space to store the other content items. If replaceable content has been overwritten by other content, the replaceable content will typically be downloaded again when memory space becomes available.

### FIELD OF THE INVENTION

Embodiments of the invention generally relates to systems and methods for controlling storage of content and, more particularly, to systems, terminals, methods, and computer program products for allocating memory for storage of content in terminals.

### BACKGROUND OF THE INVENTION

The deployment of advanced high bit-rate mobile networks has opened up new opportunities for delivering a host of services in a way that was not possible with earlier second generation wireless networks. Recent mobile network systems including third generation (3G) systems such as those specified for use with the Global System for Mobile Communications (GSM) wireless standard (which may include Wideband Code Division Multiple Access (WCDMA)), as well as General Packet Radio Service (GPRS) systems, enable the delivery of new digital services such as video calls and the playback of multimedia applications that are comprised of audio and video clips.

The increased bit rates of recent mobile network systems provide adequate performance for delivering high quality digital audio and acceptable quality moving image clips. However, at these transfer rates it may be difficult to handle exceedingly high data intensive tasks such as delivering high quality full-motion video and transferring very large data files to mobile terminals. In this regard, attempts at downloading large data files may lead to inconveniently long downloading times that can be undesirably costly for users. For this and other reasons, alternative broadband delivery techniques, such as Digital Video Broadcasting (DVB) techniques, have been investigated that could provide a practical solution for high data intensive tasks in terms of lower cost and convenience for the users involved.

The combined use of mobile telecommunications with a broadband delivery technique has been proposed in the past in order to achieve efficient delivery of digital services to users on the move. This would take advantage of existing infrastructures in the effort to provide personal communications (already prevalent) and the growing demand for Internet access, together with the expected rise of digital broadcasting, so that users can receive these services with a single device. The combination of mobile telecommunication and relatively low cost digital broadband delivery techniques provides the possibility of interactive services such as uni-directional and bi-directional services such as audio and video streaming (e.g., TV, radio, etc.), file downloads, advanced gaming applications, etc.

However, there are some challenges with developing the mobile terminals needed for downloading or otherwise receiving content, data, information or the like, even when such mobile terminals combine use of telecommunication techniques with digital broadband data broadcast techniques (e.g., DVB-T). In this regard, mobile terminals are generally capable of storing only a limited amount of data. The ability of mobile terminals to receive and thereafter store a large amount of data at a high bit rate, however, can place a heavy storage capacity burden on the terminal. This is especially the case when multiple pieces of content are delivered to the mobile terminal, with the user desiring to receive one or more pieces of content at different times for viewing at a time subsequent to receiving the content.

Often, the user may subscribe to a service that provides content on a periodic and/or scheduled basis. As such, the content provider and the mobile terminal may know in advance what pieces of content are to be delivered to the mobile terminal. By knowing in advance what content is to be delivered, the content provider (or mobile terminal) may take advantage of higher bandwidth and/or less expensive connections that may be available only at particular times and/or in particular geographic locations by delivering (or requesting) some content in advance of the intial scheduled or requested download time/date. For example, higher bandwidth connections may be available late at night and early in the morning because communication traffic may be reduced during these times. As such, content that is not scheduled or requested to be delivered until some time (e.g., several hours or several days) in the future may be downloaded to the mobile terminal during a time when higher bandwidth is available. Additionally, for a mobile terminal that is capable of communicating using more than one communication protocol or mode (i.e., a multi-mode terminal), one mode may be less expensive to use for downloading large amounts of data. For a multi-mode device capable of using, for example, GPRS and wireless local area network (WLAN) for data download, it may be less expensive to use the WLAN connection as compared to the GPRS connection. Again, content that is not scheduled or requested to be delivered until some time in the future may be downloaded to the mobile terminal during a time when the terminal is connected to a WLAN network to take advantage of the less expensive connection.

This ability to take advantage of higher bandwidth and/or less expensive connections may often be desirable. However, as this may result in content being delivered in advance of the scheduled or requested time, this may further exacerbate the heavy storage capacity burden on the mobile terminal.

In mobile terminals that also operate as telecom devices, content storage is a particularly important issue since users expect sufficiently reasonable storage capacity for necessary communication purposes which they expect to be available. While content storage is an important issue for mobile devices, content storage is also an important issue for any device that stores content and that has limited storage capacity, such as a personal digital assistant (PDA), a digital camera or camcorder, a portable audio/video/television device, a set-top box (STB), a personal video recorder (PVR), a digital video recorder (DVR), a global positioning system (GPS) receiver, a portable storage device (e.g., memory stick), a memory card (e.g., PC card), and the like.

### BRIEF SUMMARY OF THE INVENTION

A terminal, system, method, and computer program product are therefore provided that are capable of allocating memory for content storage in the terminal. More particularly, embodiments of the invention are capable of storing content as either fixed or replaceable content. Fixed content is typically content that is intended to be currently available for access by the user and is visible to the user. Replaceable content may be content that is intended to be accessible by the user at a future date or time, or content that the user does not currently have the right to view. Storing some content as replaceable content enables a service provider to take advantage of favorable network connections to download content that is not to be viewed by the user until a later date, while not preventing the user from being able to store other content if desired. This is achieved by defining rules that allow the end user and/or the terminal to overwrite other content to the memory location where replaceable content is stored, and implementing necessary file and memory management mechanisms in the terminal device. In this way, even though the replaceable content is stored to the memory of the device, the memory area to which the replaceable content is stored to is actually seen as “free” because other content can immediately use this memory area if a need arises. It is therefore possible to say that the memory area used by replaceable content is not “reserved.” Other content items may overwrite the replaceable content if necessary due to insufficient open memory space to store the other content items. If replaceable content has been overwritten by other content, the replaceable content will typically be downloaded again when memory space becomes available. Because replaceable content typically does not reserve memory space, the replaceable content stored in the terminal is typically not visible to the user. Replaceable content may be recharacterized as fixed content, with such recharacterization typically occurring when the content is published or unlocked by the content provider.

In this regard, a terminal for allocating memory comprises a storage element and a processor. The processor may be capable of determining a status of at least one content item stored in the storage element, with the status selected from the group consisting of fixed and replaceable. The processor may be further capable of determining an amount of memory space needed to store an additional content item to be received and/or stored, an amount of memory space in the storage element in which no content items are stored, and an amount of memory space in the storage element in which all content items determined to be replaceable are stored. The processor may be further capable of determining if the amount of memory space needed to store the additional content item is greater than the amount of memory space in which no content items are stored and less than a sum of the amount of memory space in which no content items are stored and the amount of memory space in which all content items determined to be replaceable are stored and then storing at least a portion of the new content item in a memory location in which at least a portion of a content item determined to be replaceable had been stored.

In one embodiment of the invention, the processor is further capable of storing identification information for the portion of the content item determined to be replaceable, and requesting and receiving the portion of the content item determined to be replaceable when memory space is available in the storage element to restore the portion of the content item determined to be replaceable.

The processor may be further capable of changing the status of the at least one content item stored in the terminal from replaceable to fixed based upon metadata contained in the at least one content item, wherein the metadata comprises at least one of user-determined priority, content provider-determined priority, publication date, and request date. Similarly, the processor may be further capable of changing the status of the at least one content item stored in the terminal from fixed to replaceable based upon metadata contained in the at least one content item.

In one embodiment of the invention, the processor may select the portion of the content item determined to be replaceable based upon metadata contained in the content item, wherein the metadata comprises at least one of user-determined priority, content provider-determined priority, publication date, and request date.

In addition to the terminal for allocating memory as described above, other aspects of the invention are directed to corresponding systems, methods, and computer program products for allocating memory.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a wireless communications system according to one embodiment of the invention including a mobile network and a data network to which a terminal is bi-directionally coupled through wireless RF links;

FIG. 2 is a functional block diagram of an entity capable of operating as a terminal, origin server, digital broadcast receiving terminal and/or a digital broadcaster, in accordance with embodiments of the invention;

FIG. 3 is a functional block diagram of a digital broadcast receiving terminal, in accordance with one embodiment of the invention;

FIG. 4 is a functional block diagram of the digital broadcaster, in accordance with one embodiment of the invention;

FIG. 5 is a schematic block diagram of a mobile station that may operate as a terminal, according to embodiments of the invention;

FIG. 6 is a functional block diagram of a terminal downloading or otherwise receiving content from a content source, in accordance with one embodiment of the invention;

FIGS. 7 and 8 are flowcharts of a method of allocating memory for storage of content in accordance with another embodiment of the present invention; and

FIG. 9 is an illustration of the allocation of memory for storage of content, in accordance with one embodiment of the invention.

### DETAILED DESCRIPTION OF THE INVENTION

Exemplary embodiments of the invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

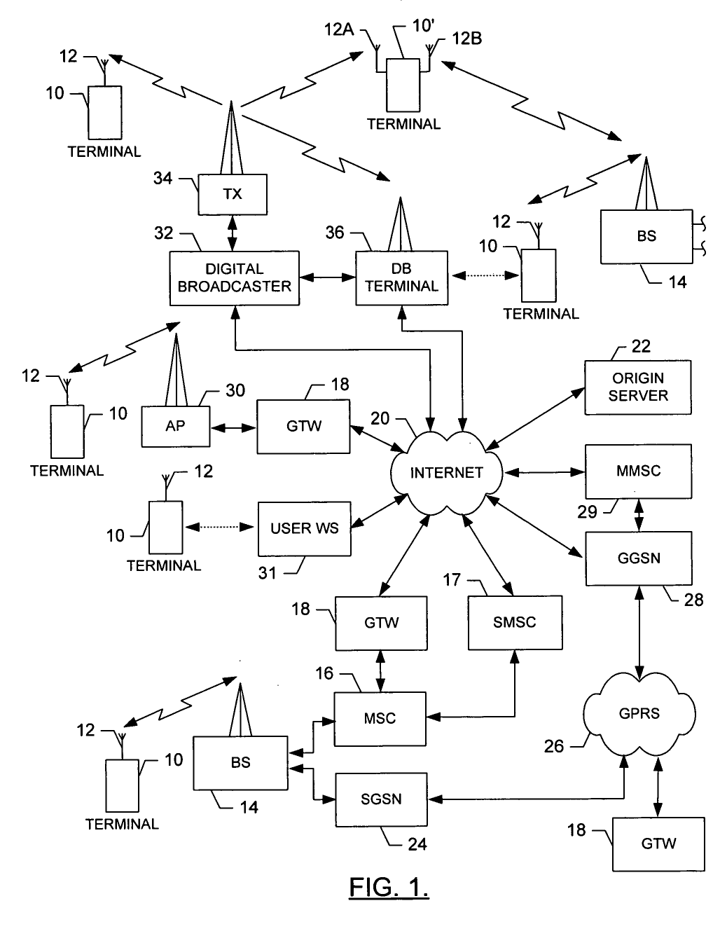

Referring to FIG. 1, describing one embodiment of the invention, an illustration of one type of terminal and system that would benefit from embodiments of the invention is provided. The system, terminal, method and computer program product of embodiments of the invention will be primarily described in conjunction with mobile communications applications. It should be understood, however, that the system, method and computer program product of embodiments of the invention can be utilized in conjunction with a variety of other applications, both in the mobile communications industries and outside of the mobile communications industries. For example, the system, terminal, method and computer program product of embodiments of the invention can be utilized in conjunction with wireline and/or wireless network (e.g., Internet) applications. Additionally, embodiments of the invention can be utilized in conjunction with any device that stores content and that has limited storage capacity, such as a personal digital assistant (PDA), a digital camera or camcorder, a portable music/audio/video/television device, a set-top box (STB), a personal video recorder (PVR), a digital video recorder (DVR), a global positioning system (GPS) receiver, a personal protable server device, a portable storage device (e.g., memory stick), a memory card (e.g., PC Card), and the like.

As shown, a terminal 10 may include an antenna 12 for transmitting signals to and for receiving signals from a base site or base station (BS) 14. The base station is a part of one or more cellular or mobile networks that each include elements required to operate the network, such as a mobile switching center (MSC) 16. As well known to those skilled in the art, the mobile network may also be referred to as a Base Station/MSC/Interworking function (BMI). In operation, the MSC is capable of routing calls to and from the terminal when the terminal is making and receiving calls. The MSC can also provide a connection to landline trunks when the terminal is involved in a call. In addition, the MSC can be capable of controlling the forwarding of messages to and from the terminal, and can also controlling the forwarding of messages for the terminal to and from a messaging center, such as short messaging service (SMS) messages to and from a SMS center (SMSC) 17.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a GTW 18, and the GTW is coupled to a WAN, such as the Internet 20. In turn, devices such as processing elements (e.g., personal computers, server computers or the like) can be coupled to the terminal 10 via the Internet. For example, as explained below, the processing elements can include one or more processing elements associated with an origin server 22 or the like, one of which being illustrated in FIG. 1.

The BS 14 can also be coupled to a signaling GPRS (General Packet Radio Service) support node (SGSN) 24. As known to those skilled in the art, the SGSN is typically capable of performing functions similar to the MSC 16 for packet switched services. The SGSN, like the MSC, can be coupled to a data network, such as the Internet 20. The SGSN can be directly coupled to the data network. In a more typical embodiment, however, the SGSN is coupled to a packet-switched core network, such as a GPRS core network 26. The packet-switched core network is then coupled to another GTW, such as a GTW GPRS support node (GGSN) 28, and the GGSN is coupled to the Internet. In addition to the GGSN, the packet-switched core network can also be coupled to a GTW 18. Also, the GGSN can be coupled to a messaging center, such as a multimedia messaging service (MMS) center 29. In this regard, the GGSN and the SGSN, like the MSC, can be capable of controlling the forwarding of messages, such as MMS messages. The GGSN and SGSN can also be capable of controlling the forwarding of messages for the terminal to and from the messaging center.

In addition, by coupling the SGSN 24 to the GPRS core network 26 and the GGSN 28, devices such as origin servers 22 can be coupled to the terminal 10 via the Internet 20, SGSN and GGSN. In this regard, devices such as origin servers can communicate with the terminal across the SGSN, GPRS and GGSN. For example, origin servers can provide content to the terminal, such as in accordance with the Multimedia Broadcast Multicast Service (MBMS). For more information on the MBMS, see Third Generation Partnership Project (3GPP) technical specification 3GPP TS 22.146, entitled: Multimedia Broadcast Multicast Service (MBMS), the contents of which are hereby incorporated by reference in its entirety.

Although not every element of every possible mobile network is shown and described herein, it should be appreciated that the terminal 10 can be coupled to one or more of any of a number of different networks through the BS 14. In this regard, the network(s) can be capable of supporting communication in accordance with any one or more of a number of first-generation (1G), second-generation (2G), 2.5G and/or third-generation (3G) mobile communication protocols or the like. For example, one or more of the network(s) can be capable of supporting communication in accordance with 2G wireless communication protocols IS-136 (Time Division Multiple Access (TDMA)), GSM, and IS-95 (Code Division Multiple Access (CDMA)). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the invention, as should dual or higher mode mobile stations (e.g., digital/analog or TDMA/CDMA/analog phones).

The terminal 10 can further be coupled to one or more wireless access points (APs) 30. The APs can comprise access points configured to communicate with the terminal in accordance with short range wireless techniques, such as, for example, radio frequency (RF), radio frequency identification (RFID), Bluetooth (BT), infrared (IrDA) or any of a number of different wireless networking techniques, including WLAN, ultra wideband (UWB), WiMax, and the like. Additionally, or alternatively, the terminal can be coupled to one or more user workstations (WS) 31. Each user workstation can comprise a computing system such as personal computers, laptop computers or the like. In this regard, the user workstations can be configured to communicate with the terminal in accordance with techniques such as, for example, RF, BT, IrDA or any of a number of different wireline or wireless communication techniques, including LAN and/or WLAN techniques. One or more of the user workstations can additionally, or alternatively, include a removable memory capable of storing content, which can thereafter be transferred to the terminal.

The APs 30 and the workstations 31 may be coupled to the Internet 20. Like with the MSC 16, the APs and workstations can be directly coupled to the Internet. In one advantageous embodiment, however, the APs are indirectly coupled to the Internet via a GTW 18. As will be appreciated, by directly or indirectly connecting the terminals and the origin server 22, as well as any of a number of other devices, to the Internet, the terminals can communicate with one another, the origin server, etc., to thereby carry out various functions of the terminal, such as to transmit data, content or the like to, and/or receive content, data or the like from, the origin server. As used herein, the terms “data,” “content,” “information” and similar terms may be used to interchangeably to refer to data capable of being transmitted, received and/or stored in accordance with embodiments of the invention. Thus, use of any such terms should not be taken to limit the spirit and scope of the invention.

Further, the terminal 10 can additionally, or alternatively, be coupled to any of a number of broadcast and/or multicast networks. For example, the terminal can be coupled to a digital video broadcasting network. As will be appreciated, for example, such a digital video broadcasting network can support communications in accordance with the Digital Video Broadcasting (DVB) standard and/or variants of the DVB standard, including DVB-T (terrestrial), DVB-MHP (multimedia home platform), DVB-H (handheld), DVB-C (cable), DVB-S (satellite) and/or DVB-IP. Further, for example, such a digital video broadcasting network can additionally or alternatively support communications in accordance with the Data Over Cable Service Interface Specification (DOCSIS), Japanese Terrestrial Integrated Service Digital Broadcasting (ISDB-T), Digital Audio Broadcasting (DAB), Digital Multimedia Broadcasting-Terrestrial (DMB-T), MediaFLO (MediaFLO is a trademark of Qualcomm, Inc.), and MBMS, and those networks provided by the Advanced Television Systems Committee (ATSC).

In many such broadcasting networks, a containerization technique is utilized in which content for transmission is placed into MPEG-2 packets which act as data containers. Thus, the containers can be utilized to transport any suitably digitized data including, but not limited to High Definition TV, multiple channel Standard Definition TV (PAUNTSC or SECAM) and, of course, broadband multimedia data and interactive services. DVB-T, for example, is a wireless point-to-multipoint data delivery mechanism developed for digital TV broadcasting, and is based on the MPEG-2 transport stream for the transmission of video and synchronized audio. As will be appreciated by those skilled in the art, DVB-T also has the capability of efficiently transmitting large amounts of data over a broadcast channel to a high number of users at a lower cost, when compared to data transmission through mobile telecommunication networks using, e.g., 3G systems. Advantageously, DVB-T has further proven to be exceptionally robust in that it provides increased performance in geographic conditions that would normally affect other types of transmissions, such as the rapid changes of reception conditions, and hilly and mountainous terrain. On the other hand, other variations of this DVB-T are being developed to account for the capabilities of handheld devices (e.g., terminals 10), such as the power consumption of such devices.

More particularly, for example, the terminal can be coupled to a digital video broadcasting (e.g., DVB-T, DVB-H, ISDB-T, ATSC, etc.) network. As will be appreciated, by directly or indirectly connecting the terminals and the digital broadcaster, the terminals can receive content, such as content for one or more television, radio and/or data channels, from the digital broadcaster. In this regard, the digital broadcaster can include, or be coupled to, a transmitter (TX) 34, such as a DVB-T TX. Similarly, the terminal can include a receiver, such as a DVB-T receiver (not shown). The terminal can be capable of receiving content from any of a number of different entities in any one or more of a different number of manners. In one embodiment, for example, the terminal can comprise a terminal 10′ capable of transmitting and/or receiving data, content or the like in accordance with a DVB (e.g., DVB-T, DVB-H, etc.) technique as well as a mobile (e.g., 1G, 2G, 2.5G, 3G, etc.) communication technique. In such an embodiment, the terminal 10′ may include an antenna 12A for receiving content from the DVB-T TX, and another antenna 12B for transmitting signals to and for receiving signals from a BS 14. For more information on such a terminal, see U.S. Patent Application Publication No. 2002/0021809, entitled: Receiver, filed Jun. 29, 2001 and published Feb. 21, 2002, the contents of which is incorporated herein by reference in its entirety.

In addition to, or in lieu of, directly coupling the terminal 10 to the digital broadcaster 32 via the TX 34, the terminal can be coupled to a digital broadcast (DB) receiving terminal 36 which, in turn, can be coupled to the digital broadcaster 32, such as directly and/or via the TX. In such instances, the digital broadcast receiving terminal can comprise a DVB-T receiver, such as a DVB-T receiver in the form of a set top box. The terminal can be locally coupled to the digital broadcast receiving terminal, such as via a personal area network. In one advantageous embodiment, however, the terminal can additionally or alternatively be indirectly coupled to the digital broadcast receiving terminal via the Internet 20.

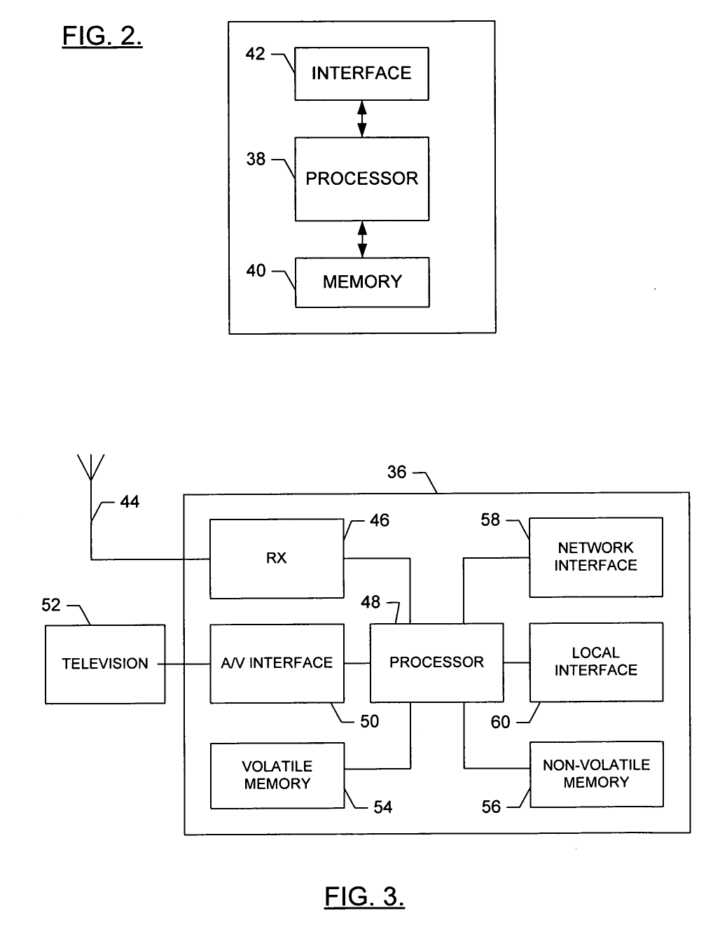

Referring now to FIG. 2, a block diagram of an entity capable of operating as a terminal 10, origin server 22, digital broadcast receiving terminal 36, and/or a digital broadcaster 32 is shown in accordance with one exemplary embodiment of the invention. The entity capable of operating as a terminal 10, origin server 22, digital broadcast receiving terminal 36, and/or a digital broadcaster 32 includes various means for performing one or more functions in accordance with exemplary embodiments of the invention, including those more particularly shown and described herein. It should be understood, however, that one or more of the entities may include alternative means for performing one or more like functions, without departing from the spirit and scope of the invention.

More particularly, for example, as shown in FIG. 2, describing one embodiment of the invention, the entity can generally include means, such as a processor 38, controller, or the like, connected to a storage element, such as memory 40, or other means for storing content. The processor can also be connected to at least one interface 42 or other means for transmitting and/or receiving data, content or the like. The memory can comprise volatile and/or non-volatile memory, and typically stores content, data or the like. For example, the memory typically stores software applications, instructions or the like for the processor to perform steps associated with operation of the entity in accordance with embodiments of the invention. Also, for example, the memory typically stores content transmitted from, or received by, the terminal, digital broadcast receiving terminal, and/or digital broadcaster. In addition, as described below, the memories can store a download manager and/or a memory manager capable of controlling storage of content received by the terminal. Although shown as separate entities, in some embodiments one or more entities may support one or more of a terminal, origin server, digital broadcast receiving terminal, and/or a digital broadcaster, logically separated but co-located within the entit(ies). For example, a single entity may support a logically separate, but co-located, terminal and digital broadcast receiving terminal. Also, for example, a single entity may support a logically separate, but co-located digital broadcast receiving terminal and digital broadcaster.

Reference is now made to FIG. 3, describing one embodiment of the invention, which illustrates a functional block diagram of a digital broadcast receiving terminal 36, in accordance with one exemplary embodiment of the invention. The terminal 36 includes various means for performing one or more functions in accordance with exemplary embodiments of the present invention, including those more particularly shown and described herein. It should be understood, however, that the terminal may include alternative means for performing one or more like functions, without departing from the spirit and scope of the present invention. As shown, the digital broadcast receiving terminal includes an antenna 44 for receiving signals from a digital broadcaster 32 and feeding the signals into a receiver (RX) 46. In turn, the receiver is capable of decrypting, demodulating and/or demultiplexing the signals, such as to extract content data. The receiver can feed the content data to means, such as a processor 48, for thereafter decoding the content data. The processor can then feed the decoded signal into an audio/video (A/V) interface 50, which can convert signals to a form suitable for display by a monitor, such as a television set 52.

The digital broadcast receiving terminal 36 can include volatile memory 54, such as volatile Random Access Memory (RAM) including a cache area for the temporary storage of data. The digital broadcast receiving terminal can also include non-volatile memory 56, which can be embedded and/or may be removable. The non-volatile memory can additionally or alternatively comprise an EEPROM, flash memory, hard disk or the like. The memories can store any of a number of pieces of information, content and data, used by the digital broadcast receiving terminal to implement the functions of the digital broadcast receiving terminal. For example, as indicated above, the memories can store content, such as that received from a digital broadcaster 32.

The digital broadcast receiving terminal 36 can also include one or more interface means for sharing and/or obtaining data from electronic devices, such as terminals 10 and/or digital broadcasters 32. More particularly, the digital broadcast receiving terminal can include a network interface means 58, for sharing and/or obtaining data from a network, such as the Internet 20. For example, the network interface means can include an Ethernet Personal Computer Memory Card International Association (PCMCIA) card (also termed a PC card) configured to transmit and/or receive data to and from a network, such as the Internet.

The digital broadcast receiving terminal 36 can also include one or more local interface means 60 for locally sharing and/or obtaining data from electronic devices, such as a terminal. For example, the digital broadcast receiving terminal can include a radio frequency transceiver and/or an infrared (IR) transceiver so that data can be shared with and/or obtained in accordance with radio frequency and/or infrared transfer techniques. Additionally, or alternatively, for example, the digital broadcast receiving terminal can include a Bluetooth (BT) transceiver 52 operating using Bluetooth brand wireless technology developed by the Bluetooth Special Interest Group such that the digital broadcast receiving terminal can share and/or obtain data in accordance with Bluetooth transfer techniques. Further, the digital broadcast receiving terminal can additionally or alternatively be capable of sharing and/or obtaining data in accordance with any of a number of different wireline and/or wireless networking techniques, including LAN and/or WLAN techniques.

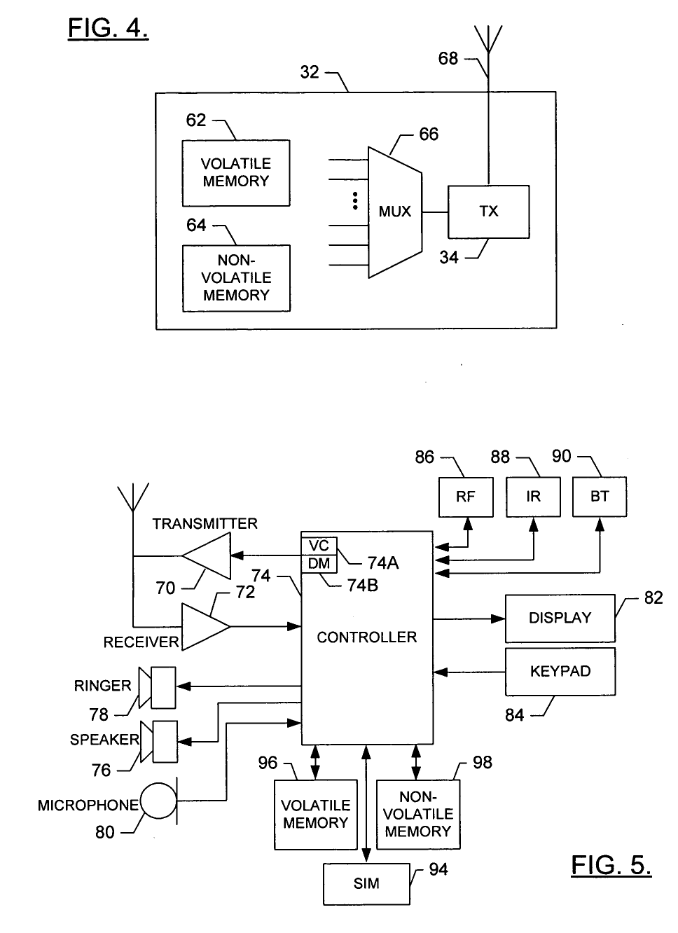

Reference is now made to FIG. 4, describing one embodiment of the invention, which illustrates a functional block diagram of the digital broadcaster 32 of one embodiment of the invention. Like the digital broadcast receiving terminal 36, the digital broadcaster can include volatile memory 62, such as volatile Random Access Memory (RAM) including a cache area for the temporary storage of data. The digital broadcaster can also include non-volatile memory 64, which can be embedded and/or may be removable. The non-volatile memory can additionally or alternatively comprise an EEPROM, flash memory, hard disk or the like. The memories can store any of a number of pieces of information, content and data, used by the digital broadcaster to implement the functions of the digital broadcaster. For example, as indicated above, the memories can store content, such as content for a television channel and other content for a number of other television, radio and/or data channels.

The digital broadcaster 32 can also include a multiplexer 66, which can be capable of multiplexing content for a number of television, radio and/or data channels. The multiplexer can then feed the resulting signal into a TX 34, which can be separate from the digital broadcaster, as shown in FIG. 1, or incorporated within the digital broadcaster, as shown in FIG. 4. Irrespective of where the TX is located relative to the digital broadcaster, the TX can receive the signal from the multiplexer for encryption, modulation, amplification and/or transmission, such as via an antenna 68. In this regard, for example, the digital broadcaster can be capable of directly or indirectly transmitting content to a digital broadcast receiving terminal 36 and/or a terminal 10, such as in accordance with a digital broadcasting technique, such as DVB-T.

In accordance with a number of digital broadcasting techniques, such as DVB-T, Internet Protocol (IP) Datacast (IPDC) can be utilized to provide audio, video and/or other content to terminals 10. In this regard, the digital broadcaster 32 can be capable of providing IP datacasting content to the terminal utilizing a digital broadcasting technique. As will be appreciated by those skilled in the art, digital broadcasting techniques such as DVB-T are essentially mobile in nature with a transmission site associated with each of a number of different cells. DVB-T, for example, uses MPEG-2 transport streams, and as such, IP data can be encapsulated into DVB transmission signals sent from the digital broadcaster, or more particularly the TX 34. Data streams including IP datagrams can be supplied from several sources, and can be encapsulated by an IP encapsulator (not shown). The IP encapsulator, in turn, can feed the encapsulated IP data streams into the data broadcasting (e.g., DVB-T) network.

The encapsulated IP data streams can then be transported to one or more transmission sites, where the transmission sites form cells of the data broadcasting network. For example, the encapsulated IP data streams can be transported to one or more transmission sites on an MPEG-2 transport stream for subsequent transmission over the air directly to the terminals, or to a receiver station serving one or more terminals. As will be appreciated, the MPEG-2 transport stream, from production by the IP encapsulator, to reception by the terminals or the receiver station, is typically uni-directional in nature. In this regard, IP packets containing the data can be embedded in multi-protocol encapsulation (MPE) sections that are transported within transport stream packets.

In addition to the IP packets, the MPE sections can also include forward error correction (FEC) information and time slicing information. By including information such as time slicing information, data can be conveyed discontinuously with the receiver (e.g., terminal 10), being capable of saving battery power by switching off when no data is being transmitted to the receiver. In other terms, in accordance with one time slicing technique, instead of using the current default method of continuous digital broadcasting (e.g., DVB-T) transmission, a time division multiplex-type of allocation technique can be employed (e.g., DVB-H). With such an approach, then, services can be provided in bursts, allowing a receiver to power down when the receiver is not receiving data, and allowing the receiver to power up to receive data packets, as necessary.

FIG. 5 describing one embodiment of the invention, illustrates a functional diagram of a mobile station that may operate as a terminal 10, according to embodiments of the invention. It should be understood, that the mobile station illustrated and hereinafter described is merely illustrative of one type of terminal that would benefit from embodiments of the invention and, therefore, should not be taken to limit the scope of the invention. While several embodiments of the mobile station are illustrated and will be hereinafter described for purposes of example, other types of mobile stations, such as portable digital assistants (PDAs), pagers, laptop computers, digital cameras or camcorders, portable audio/video/television devices, and other types of voice and text communications systems, can readily employ embodiments of the invention. Additionally, other non-mobile devices, such as personal computers (PCs), set-top boxes (STBs), personal video recorders (PVRs), digital video recorders (DVRs), and the like can readily employ embodiments of the invention.

The mobile station includes various means for performing one or more functions in accordance with exemplary embodiments of the invention, including those more particularly shown and described herein. It should be understood, however, that the mobile station may include alternative means for performing one or more like functions, without departing from the spirit and scope of the invention. More particularly, for example, as shown in FIG. 5, the mobile station can include a transmitter 70, a receiver 72, and means, such as a controller 74 or other processor, that provides signals to and receives signals from the transmitter and receiver, respectively. These signals include signaling information in accordance with the air interface standard of the applicable mobile system, and also user speech and/or user generated data. In this regard, the mobile station can be capable of operating with one or more air interface standards, communication protocols, modulation types, and access types. More particularly, the mobile station can be capable of operating in accordance with any of a number of first-generation (1G), second-generation (2G), 2.5G and/or third-generation (3G) communication protocols or the like. For example, the mobile station may be capable of operating in accordance with 2G wireless communication protocols IS-136 (TDMA), GSM, and IS-95 (CDMA). Also, for example, the mobile station may be capable of operating in accordance with 2.5G wireless communication protocols GPRS, Enhanced Data GSM Environment (EDGE), or the like. The mobile station can additionally or alternatively be capable of operating in accordance with any of a number of different digital broadcasting techniques, such as the DVB technique (e.g., DVB-T, ETSI Standard EN 300 744). The mobile station can also be capable of operating in accordance with any of a number of different broadcast and/or multicast techniques, such as the MBMS technique (e.g., 3GPP TS 22.146). Further, the mobile station can be capable of operating in accordance with ISDB-T, DAB, ATSC techniques or the like. Some narrow-band AMPS (NAMPS), as well as TACS, mobile stations may also benefit from embodiments of the invention, as should dual or higher mode mobile stations (e.g., digital/analog or TDMA/CDMA/analog phones).

It is understood that the controller 74 includes the circuitry required for implementing the audio and logic functions of the mobile station. For example, the controller may be comprised of a digital signal processor device, a microprocessor device, and various analog to digital converters, digital to analog converters, and other support circuits. The control and signal processing functions of the mobile station are allocated between these devices according to their respective capabilities. The controller thus also includes the functionality to convolutionally encode and interleave message and data prior to modulation and transmission. The controller can additionally include an internal voice coder (VC) 74A, and may include an internal data modem (DM) 74B. Further, the controller may include the functionality to operate one or more software applications, which may be stored in memory.

The mobile station also comprises a user interface including a conventional earphone or speaker 76, a ringer 78, a microphone 80, a display 82, and a user input interface, all of which are coupled to the controller 74. The user input interface, which allows the mobile station to receive data, can comprise any of a number of devices allowing the mobile station to receive data, such as a keypad 84, a touch display (not shown) or other input device. In embodiments including a keypad, the keypad includes the conventional numeric (0-9) and related keys (#, *), and other keys used for operating the mobile station.

The mobile station can also include one or more means for sharing and/or obtaining data from electronic devices, such as another terminal 10, an origin server 22, an AP 30, a digital broadcast receiving terminal 36, a digital broadcaster 32 or the like, in accordance with any of a number of different wireline and/or wireless techniques. For example, the mobile station can include a radio frequency (RF) transceiver 86 and/or an infrared (IR) transceiver 88 such that the mobile station can share and/or obtain data in accordance with radio frequency and/or infrared techniques. Also, for example, the mobile station can include a Bluetooth (BT) transceiver 90 such that the mobile station can share and/or obtain data in accordance with Bluetooth transfer techniques. Although not shown, the mobile station may additionally or alternatively be capable of transmitting and/or receiving data from electronic devices according to a number of different wireline and/or wireless networking techniques, including LAN and/or WLAN techniques. In this regard, as shown in FIG. 1 with respect to terminal 10′, the mobile station may include an additional antenna or the like to transmit and/or receive data from such electronic devices (e.g., digital broadcaster).

The mobile station can further include memory, such as a subscriber identity module (SIM) 94, a removable user identity module (R-UIM) or the like, which typically stores information elements related to a mobile subscriber. In addition to the SIM, the mobile station can include other memory. In this regard, the mobile station can include volatile memory 96. Also, the mobile station can include other non-volatile memory 98, which can be embedded and/or may be removable. For example, the other non-volatile memory can comprise embedded or removable multimedia memory cards (MMC's), Memory Sticks manufactured by Sony Corporation, EEPROM, flash memory, hard disk or the like.

The memories 94, 96, 98 can store any of a number of pieces of information, and data, used by the mobile station to implement the functions of the mobile station. For example, the memories can store an identifier, such as an international mobile equipment identification (IMEI) code, international mobile subscriber identification (IMSI) code, mobile station integrated services digital network (MSISDN) code or the like, capable of uniquely identifying the mobile station, such as to the MSC 16. The memories can also store content, such as that received from an origin server 22 and/or a digital broadcast receiving terminal. Also, for example, the memories can store one or more presentation applications such as a conventional text viewer, audio player, video player, multimedia viewer or the like. In addition, as described below, the memories can store a download manager and/or a memory manager capable of controlling storage of content received by the mobile station.

The content sources that are capable of originating content to user terminals may be any device, server, or service provider in any network that is connected to the user terminal. This device or server may be, for example, another user terminal, such as a mobile phone, personal computer, digital camera, digital camcorder, digital music/audio device, etc. This network may be, for example, a peer-to-peer (P2P) network. These devices, servers, and/or service providers may have content agreements and/or downloading applications/means that manage available content.

As explained in the background section, terminals 10 are generally capable of storing only a limited amount of data. And as such, the ability of content sources to deliver a large amount of data at a high bit rate to a terminal can place a heavy storage capacity burden on the terminal. This is especially the case when multiple pieces of content are delivered to the mobile terminal in advance of the scheduled or requested time. Embodiments of the invention are therefore capable of allocating memory for content storage in the terminal. More particularly, embodiments of the invention are capable of storing content as either fixed or replaceable content. Fixed content is typically content that is intended to be currently available for access by the user. Fixed content may be stored in the terminal by the user. For example, the user may take a digital photograph using a digital camera included in the terminal, and store the photograph in the memory of the terminal. The stored photograph would typically be readily accessible by the user. Fixed content may also include content items that are downloaded from a content provider at the scheduled or requested time. Fixed content would typically be visible to the user, via a directory of stored content items.

Replaceable content may be content that is intended to be accessible by the user at a future date or time (this may be termed future content). As discussed in the background, such future content may be content that was requested by the user to be delivered in the future or that was scheduled to be delivered in the near future according to a subscription agreement with a content provider, but was downloaded to the terminal in advance of the requested/scheduled date to take advantage of a high bandwidth and/or low cost network connection. Such future content would typically be released and made accessible to the user (i.e., “published”) by the content provider on the requested/scheduled date. Replaceable content may also be content that the user does not currently have the right to view (this may be termed locked content), and may include, for example, pay-per-view movies. The right to view such content would typically have to be purchased by the user, and the content would then typically be released and made accessible to the user by the content provider. A content provider may desire to download such locked content to a terminal without being certain that the user will purchase the right to view the content in order to enable the content to be immediately accessible to the user once the right to access the content is purchased, rather than having to wait for the content to be downloaded. Such immediate accessibility may increase the likelihood that the user may purchase the right to access the content.

Storing some content, such as future content and locked content, as replaceable content enables a service provider to take advantage of favorable network connections to download content that is not to be viewed by the user until a later date, while not preventing the user from being able to store other content if desired. This is possible because, while replaceable content may be stored in the storage element in the terminal, the replaceable content typically does not reserve memory space in the storage element. Because the replaceable content typically does not reserve memory space, other content items may overwrite the replaceable content if necessary due to insufficient open memory space (i.e., memory space in which no content is stored) to store the other content items. Fixed content may overwrite replaceable content. Additionally, replaceable content may overwrite other replaceable content, as explained below. If replaceable content has been overwritten by other content, the replaceable content will typically be downloaded again when memory space becomes available. Because replaceable content typically does not reserve memory space, the replaceable content stored in the terminal may or may not be visible to the user. For example, future content that is stored as replaceable content would typically not be visible to the user until the content is published. However, locked content that is stored as replaceable content may be visible to the user such that the user can see what content items are available for which the user can purchase the right to view. In some situations there may be replaceable content stored in the terminal that has a small portion (e.g., one segment) that has been overwritten and is therefore not stored in the terminal. Even though such content may have a missing portion, if the missing portion is small enough that the missing portion can be quickly downloaded, the entire content item may appear to the user to be in the terminal and available.

Replaceable content may be recharacterized as fixed content, with such recharacterization typically occurring when the content is published or unlocked by the content provider. Additionally, fixed content may be recharacterized as replaceable content. For example, the user may have downloaded and viewed a movie, but has not decided whether or not to view the movie again. In such a situation, the user could recharacterize the movie as replaceable, such that the movie may be viewed again but also may be overwritten with higher priority content if necessary.

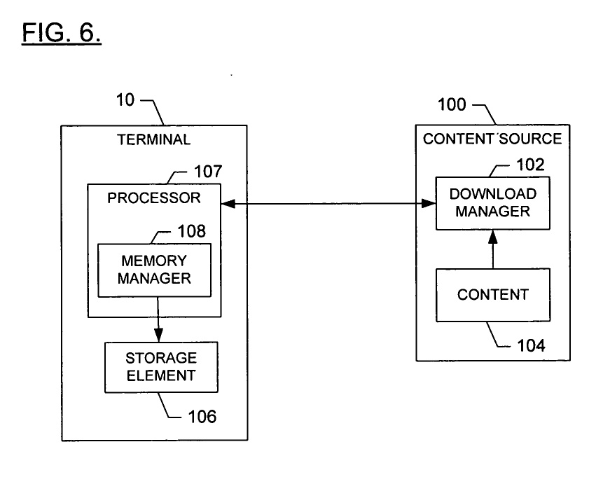

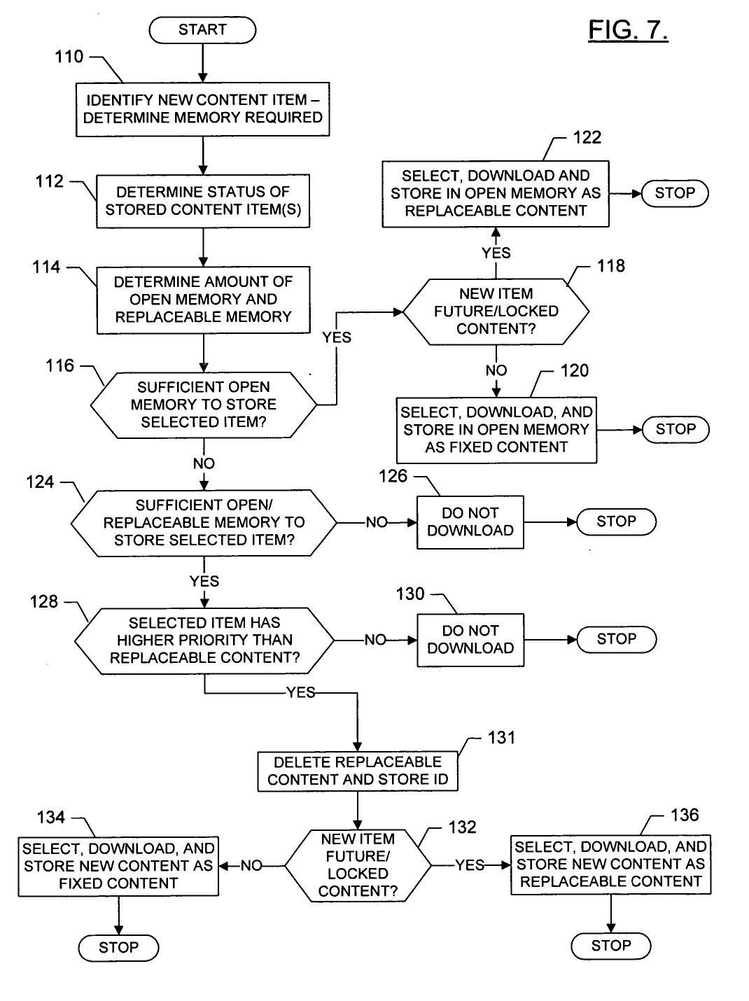

Reference is now drawn to FIG. 6 describing one embodiment of the invention, which illustrates a functional block diagram of a terminal 10, and FIG. 7 which illustrates a flowchart of a method of downloading or otherwise receiving content, in accordance with one exemplary embodiment of the invention. More particularly, FIG. 6 illustrates a functional block diagram of a terminal receiving content from a content source 100, such as an origin server 24, a SMSC 17, a MMSC 29, a digital broadcaster 32, a digital broadcast receiving terminal 36 or the like, in accordance with one advantageous embodiment of the invention. As shown and described below, the content source operates a download manager 102 to control the download of content from the content source, and the terminal operates a memory manager 108 to control the storage of content and the allocation of memory at the terminal. It should be understood, however, that although the content source is shown and described herein as operating the download manager and the terminal is shown as operating the memory manager, the download manager and the memory manager can be operated from any of a number of different network entities within the system including, for example, the terminal. Also, as described herein, the download manager and the memory manager typically comprise software capable of being stored within memory (e.g., memory 40), and operated by a processor (e.g., processor 38). It should be understood, however, that the download manager and the memory manager can alternatively comprise other means, such as firmware or hardware, without departing from the spirit and scope of the invention.

As shown in FIG. 6, the terminal 10 comprises means, such as a processor 107, which is capable of selecting content to be stored in the storage element 106 of the terminal. The content may be generated by the terminal, such as by using a digital camera contained within the terminal, or the content may be downloaded via a network from a content source, such as content 104 in content source 100. Although not shown, in one typical embodiment, a user of the terminal can subscribe, such as with the digital broadcaster, to content from one or more television, radio and/or data channels. In such instances, the selected item(s) of content can comprise those item(s) of content in accordance with the subscription. As will be appreciated, the selection of one or more item(s) of content can comprise a selection of item(s) of content for delivery to the terminal at one or more instances, such as during one or more download sessions of the terminal. Likewise, the selection can comprise a selection of item(s) of content for delivery to the terminal periodically, such as in accordance with a subscription for the periodic delivery of content from one or more television, radio and/or data channels. Typically in the case of a subscription, the download manager 102 of the content source 100 will determine when specific content is to be downloaded to the terminal. The download manager will typically notify the terminal that one or more items of content are ready to be downloaded. This notification will typically include information about the content item(s), such as the size of the item(s). The terminal may then select one or more of the items and request download of the selected items from the content source. In this way, both the terminal and the content source may together coordinate the selection of content to be downloaded. Additionally, the download manager 102 may notify the terminal that content is ready to be downloaded in advance of the requested/scheduled download date/time, or that locked content is ready to be downloaded, to take advantage of favorable network connections as discussed above. The notification to the terminal in such situations would typically include status information, such as that the content to be downloaded is future content or locked content. The terminal may transmit information to the content source regarding the terminal's current network connection to enable the content source to determine if a favorable network connection exists such that it may be desirable for future and/or locked content to be downloaded to the terminal. The download manager 102 is typically capable of receiving, from the terminal 10, a selection of one or more pieces of content to transmit or otherwise send to the terminal in response to the notification sent to the terminal.

When content items are downloaded to a terminal, metadata is typically included in the content. This metadata may include information to enable the terminal to determine a priority of each content item, as discussed below, such as service provider determined priority, user determined priority, content specific time schedule (e.g., date and/or time), publication date, request date, access right information, and the like. The metadata may be included in a header of a content item or in a separate metadata packet.

Before the processor 107 selects content to download, however, the processor typically determines if sufficient memory space is available in the terminal to store the new content. One known approach to this involves simply determining if the amount of open memory space (i.e., memory space in which no content is stored) is greater than the size of the content to be downloaded. If so, the processor may select and download the content from the content source, and if not the processor would not select and download the content. Another approach is disclosed in U.S. patent application Ser. No. 10/738,836, entitled System and Associated Terminal, Method and Computer Program Product for Controlling Memory for Storage of Content, filed Dec. 16, 2003, the contents of which are incorporated herein in its entirety. In this approach, if sufficient open memory space is not available, one or more items of the already stored content may be deleted from the terminal based on a deletion priority value.

In embodiments of the invention, content items are stored in the storage element as either fixed content or replaceable content as discussed above. When the processor 107 is attempting to determine if sufficient memory space is available to store new content, the processor may consider the status (i.e., fixed or replaceable) of the content already stored in the terminal. The terminal may consider deleting some replaceable content to ensure sufficient memory space for the new content. In this regard, processor 107 may, such as by using memory manager 108, identify the new content item that may be downloaded or otherwise stored on the terminal and determine the memory space required to store the new content item. See block 110 of FIG. 7 describing one embodiment of the invention. The processor may then determine the status (fixed or replaceable) of each content item that is already stored in the terminal. See block 112. By knowing the status of each stored content item, the processor may then determine the amount of open memory and the amount of memory occupied by those content items identified as replaceable (such memory may be termed replaceable memory). See block 114. The processor may then determine if there is sufficient open memory to store the new content. See block 116. If there is sufficient open memory to store the new content, the new content may be selected, downloaded and stored in the storage element 106. The new content may be stored as fixed content or replaceable content, depending for example on whether the new content is future content, locked content, or neither. See block 118. If the new content is future or locked content, the new content may be stored as replaceable content. See block 122. Otherwise, the new content may be stored as fixed content. See block 120.

If the processor determines in block 116 that there is not sufficient open memory to store the new content, the processor will typically determine if the amount of open memory plus the amount of replaceable memory is together sufficient to store the new content. See block 124. If the combined open memory and replaceable memory is not sufficient to store the new content, then the new content would typically not be selected for download. See block 126. If the combined open memory and replaceable memory is sufficient to store the new content, then it would typically be determined whether some or all of the replaceable content should be deleted to allow some or all of the new content to be stored in the terminal in place of the replaceable content. This determination typically involves comparing a priority of the replaceable content to a priority of the new content. This priority may be based on a number of different factors, such as the type of content (e.g., fixed content would typically have a higher priority than replaceable content, and future content would typically have a higher priority than locked content), the requested/scheduled date of future content (e.g., an earlier requested/scheduled date would typically have a higher priority than a later date), historical usage data (e.g., locked content of a type that the user has previously purchased the right to view would typically have a higher priority date than locked content of a type that the user has never before purchased), user-determined priority (e.g., the type of locked content that the user is more likely to prefer), and content provider-determined priority (e.g., the type of locked content that provides higher profit margins to the content provider). If the combination of the open memory and the replaceable memory with a lower priority than the new content is not sufficient to store the new content, then the new content would typically not be selected for download. See block 130.

If only one content provider is downloading replaceable content, then content provider-determined priority may be readily used. If more than one content provider are downloading replaceable content to a terminal and the content providers use different metadata formats, then the memory manager of the terminal may have difficulty determining the relative priority of the different replaceable content items. In such a situation, the memory manager may need to use user-determined priority. Alternatively, if the different content providers use a standardized metadata format, the priorities of different content items from different content providers may be readily compared.

If the combination of the open memory and the replaceable memory with a lower priority than the new content is sufficient to store the new content, enough of the replaceable content would typically be deleted from the storage element to free up storage space so that, in combination with the open memory, the new content can be downloaded and stored. See block 131. Identifying information for the deleted replaceable content would typically be stored in the storage element to enable the deleted content to be restored when memory space becomes available. See block 131. As discussed above, the new content may be stored as fixed content or replaceable content, depending for example on whether the new content is future content or locked content. See block 132. If the new content is future or locked content, the new content may be stored as replaceable content. See block 136. Otherwise, the new content may be stored as fixed content. See block 134.

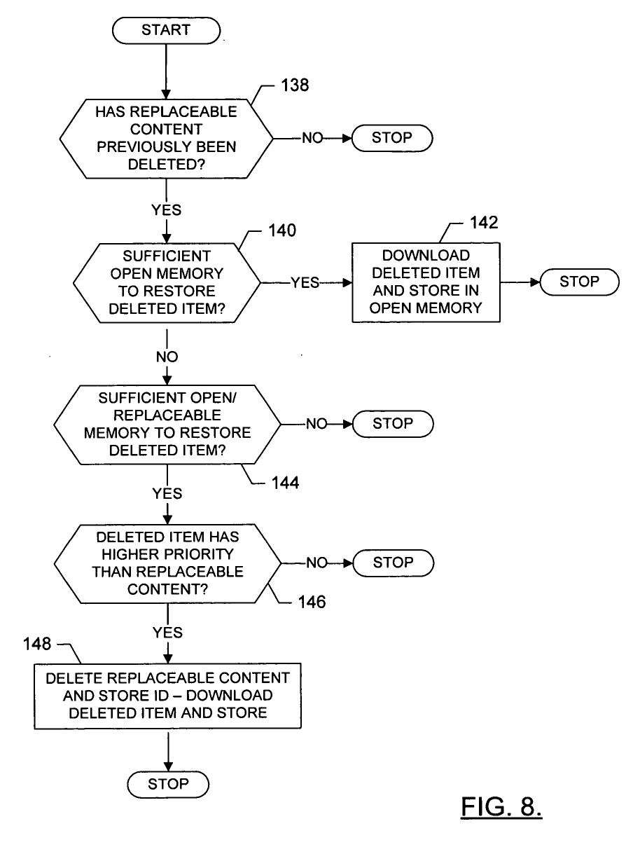

As discussed above, identifying information for the deleted replaceable content would typically be stored in the storage element to enable the deleted content to be restored when memory space becomes available. Memory manager 108 of processor 107 would typically repeatedly assess whether memory space is available to restore replaceable content that had previously been deleted to free up space to store new content. The assessment may be performed on a scheduled basis, such as once per hour or twice daily. Alternatively, the assessment may be performed upon the occurrence of an event. For example, the memory manager may perform the assessment every time a content item is deleted from the storage element. Referring now to FIG. 8, which illustrates a flowchart of a method of restoring replaceable content that had previously been deleted, in accordance with one exemplary embodiment of the invention, the processor would typically determine if replaceable content had previously been deleted but not yet restored. See block 138 of FIG. 8 describing one embodiment of the invention. The deleted replaceable content may have been one or more portions of one or more replaceable content items, or one or more complete replaceable content items. If replaceable content had previously been deleted but not yet restored, the processor would typically determine if there is sufficient open memory in which to restore the deleted content. See block 140. If there is sufficient open memory to restore the deleted content, the processor of the terminal would typically send a request to the content originator such that the deleted content (which may be one or more complete content items or one or more pieces of a content item) may be downloaded and stored in the storage element 106. See block 142. If the processor determines in block 140 that there is not sufficient open memory to restore the deleted content, the processor will typically determine if the amount open memory plus the amount of replaceable memory is together sufficient to restore the deleted content. See block 144. If the combined open memory and replaceable memory is sufficient to restore the deleted content, then it would typically be determined whether some or all of the replaceable content should be deleted to allow some or all of the deleted content to be restored in the terminal in place of the replaceable content. This determination typically involves comparing a priority of the replaceable content to a priority of the deleted content. See block 146. This would typically be a similar priority determination as discussed above, and may be based on a number of different factors, such as the type of content, the requested/scheduled date of future content, historical usage data, user-determined priority, and content provider-determined priority. If the combination of the open memory and the replaceable memory with a lower priority than the deleted content is sufficient to store the new content, enough of the replaceable content would typically be deleted from the storage element to free up storage space so that, in combination with the open memory, the processor of the terminal would typically send a request to the content originator such that the deleted content (which again may be one or more complete content items or one or more pieces of a content item) can be downloaded and restored. See block 148.

FIGS. 7 and 8 illustrate one exemplary method of allocating memory for storage of content, however many other methods may be used. Such methods will typically involve the client and the server negotiating to determine the desired set of replaceable content to appear in the end user terminal. As discussed above, this desired set may be determined based on the usage profile of the end user (e.g., the end user has previously used content from channels a, b and c more often than channels x and y, therefore, channels a, b, and c may have a higher priority), publication time, and many other factors.

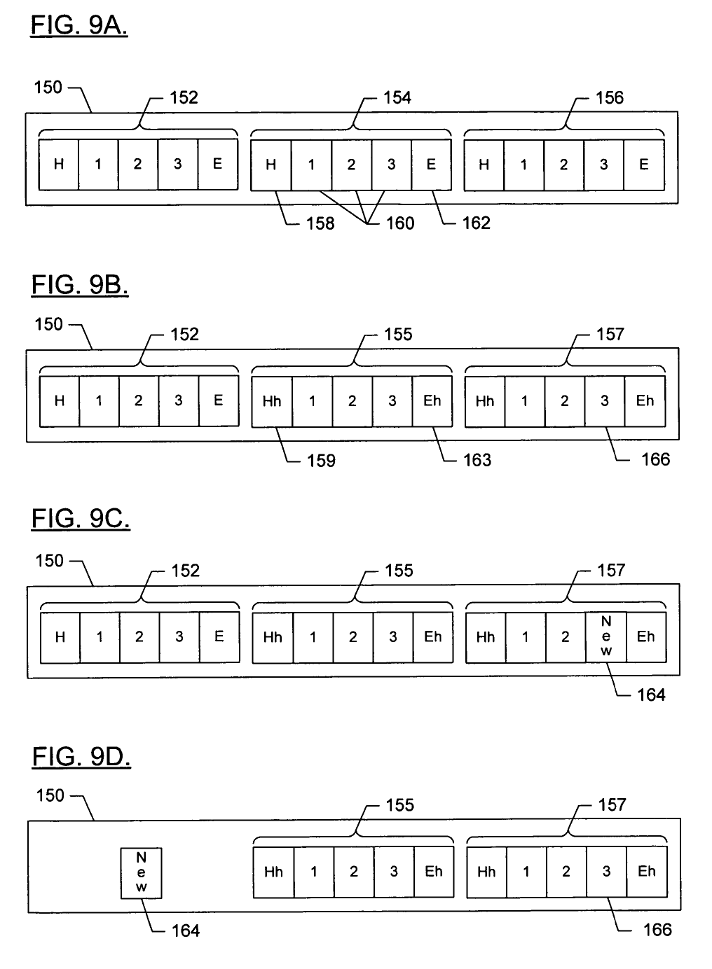

Referring now to FIGS. 9A-9D, describing one embodiment of the invention, an example of allocation of memory as fixed and replaceable content is illustrated, in accordance with one exemplary embodiment of the invention. FIGS. 9A-9D illustrate memory allocation within a storage element 150. Storage element 150 has a capacity of 9 megabytes (MB). FIG. 9A illustrates three content items 152, 154, 156 stored in storage element 150. Each content item comprises a header 158, an end 162, and payload segments 160. In this example, it is assumed that each payload segment is 1 MB in size and that the header and end consume a negligible amount of memory space. All three content items illustrated in FIG. 9A are fixed content items. As such, storage element 150 has no capacity to store any other content items because the 9 MB capacity is filled with three items of 3 MB each. To store any additional content items in the storage element of FIG. 9A would typically require that the user delete one or more of content items 152, 154, 156.

Referring now to FIG. 9B, storage element 150 is illustrated with three content items stored, however content items 155 and 157 are replaceable content. Content items 155 and 157 may be, for example, future content or locked content as discussed above. The determination to store content items 155 and 157 as replaceable content would typically be based on metadata (not illustrated) contained in the content items. As discussed above, the metadata may be included in the header (H or Hh) or in a separate metadata packet. As replaceable content, content items 155 and 157 would typically be hidden (as indicated by header 159 illustrated as “Hh” and end 163 illustrated as “Eh”) and not able to be viewed by the user. In this illustration, the memory allocation of the terminal would display as 3 MB used out of 9 MB capacity (i.e., 6 MB free). If, for example, content item 155 is hidden because content item 155 is future content that is scheduled to be published the following day, when content item 155 is published header 159 and end 163 would typically change to indicate that content item 155 is now fixed content and is visible to the user.

If the user of a terminal having storage element 150 as illustrated in FIG. 9B desired to store new content, the memory manager would typically determine if some or all of the replaceable content items 155 and 157 may be deleted to enable the new content to be stored, as discussed above and illustrated in FIG. 7. For example, the user may take a digital photograph that is 1 MB in size with a camera contained in the terminal. Such a photograph would typically be stored (if space is available) as fixed content. As fixed content, the photograph would typically have a higher priority than the replaceable content items 155 and 157. As such, the memory manager would typically delete enough of replaceable content items 155 and 157 to free 1 MB of memory, and store the digital photograph in the memory location from which the replaceable content was deleted. This deletion of replaceable content and storage of new content in place of the deleted content is illustrated in FIG. 9C. In FIG. 9C, segment 166 (which is 1 MB in size) of replaceable content item 157 has been deleted and new content item 164 (which is 1 MB in size) has been stored in place of the deleted segment. Where there is more replaceable content than is needed to delete to store the new content (as in FIG. 9B, in which there is 6 MB of replaceable content and 1 MB of new content to be stored), the memory manager will typically determine which replaceable content to delete based on the relative priority of each replaceable content item (which may be determined based on metadata in each content item). For example, in FIG. 9C the memory manager may have deleted a portion of content item 157 because content item 157 has a later requested/scheduled date than content item 155.

As discussed above and illustrated in FIG. 8, the deleted replaceable content may be restored when memory space becomes available. This is illustrated in FIG. 9D, in which fixed content item 152 has been deleted by the user, such that 3 MB of storage space is freed up. Segment 166 of content item 157 may now be restored, such that content item 157 is again complete. While FIG. 9D indicates that content item 164 was moved to a different memory location within storage element 150 and segment 157 restored in its original memory location, this is for illustration purposes only. Content item 164 may be kept in the same memory location, and restored segment 157 may be stored in one of the memory locations that had been occupied by content item 152. Typically, segments of a content item do not need to be stored in adjacent memory locations. Rather, segments can be stored in any available memory location and the memory manager or other similar function would maintain a record of the memory location of each segment to enable the complete content item to be retrieved from disparate memory locations.

According to one exemplary aspect of the invention, the functions performed by one or more of the entities of the system, such as the terminal 10, may be performed by various means, such as hardware and/or firmware, including those described above, alone and/or under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

In this regard, FIGS. 7 and 8 are flowcharts of methods and program products according to the invention. It will be understood that each step of the flowchart, and combinations of steps in the flowchart, can be implemented by computer program instructions. These computer program instructions may be loaded onto a computer or other programmable apparatus to produce a machine, such that the instructions which execute on the computer or other programmable apparatus create means for implementing the functions specified in the flowchart step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart step(s).

Accordingly, steps of the flowchart support combinations of means for performing the specified functions, combinations of steps for performing the specified functions and program instruction means for performing the specified functions. It will also be understood that each step of the flowchart, and combinations of steps in the flowchart, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A terminal for allocating memory, the terminal comprising:
a storage element; and
a processor capable of determining a status of at least one content item stored in the storage element, the status selected from the group consisting of fixed and replaceable; the processor further capable of determining an amount of memory space needed to store an additional content item to be stored, an amount of memory space in the storage element in which no content items are stored, and an amount of memory space in the storage element in which all content items determined to be replaceable are stored; the processor further capable of determining if the amount of memory space needed to store the additional content item is greater than the amount of memory space in which no content items are stored and less than a sum of the amount of memory space in which no content items are stored and the amount of memory space in which all content items determined to be replaceable are stored and then storing at least a portion of the additional content item in a memory location in which at least a portion of a content item determined to be replaceable had been stored.

2. The terminal of claim 1, wherein the processor is further capable of storing identification information for the portion of the content item determined to be replaceable; and the processor is further capable of requesting and receiving the portion of the content item determined to be replaceable when memory space is available in the storage element to restore the portion of the content item determined to be replaceable.

3. The terminal of claim 1, wherein the processor is further capable of changing the status of the at least one content item stored in the terminal from replaceable to fixed based upon metadata contained in the at least one content item.

4. The terminal of claim 3, wherein the metadata comprises at least one of user-determined priority, content provider-determined priority, publication date, and request date.

5. The terminal of claim 1, wherein the processor is further capable of changing the status of the at least one content item stored in the terminal from fixed to replaceable based upon metadata contained in the at least one content item.

6. The terminal of claim 1, wherein the processor selects the portion of the content item that is determined to be replaceable based upon metadata contained in the content item.

7. A system for allocating memory, the system comprising:
a network entity capable of providing a plurality of content items to a terminal; and
a terminal, the terminal comprising:
a storage element; and
a processor capable of determining a status of at least one content item stored in the storage element, the status selected from the group consisting of fixed and replaceable; the processor further capable of determining an amount of memory space needed to store an additional content item to be stored, an amount of memory space in the storage element in which no content items are stored, and an amount of memory space in the storage element in which all content items determined to be replaceable are stored; the processor further capable of determining if the amount of memory space needed to store the additional content item is greater than the amount of memory space in which no content items are stored and less than a sum of the amount of memory space in which no content items are stored and the amount of memory space in which all content items determined to be replaceable are stored and then storing at least a portion of the additional content item in a memory location in which at least a portion of a content item determined to be replaceable had been stored.

8. The system of claim 7, wherein the processor is further capable of storing identification information for the portion of the content item determined to be replaceable; and the processor is further capable of requesting and receiving the portion of the content item determined to be replaceable from the network entity when memory space is available in the storage element to restore the portion of the content item determined to be replaceable.

9. The system of claim 7, wherein the processor is further capable of changing the status of the at least one content item stored in the device from replaceable to fixed based upon metadata contained in the at least one content item.

10. The system of claim 9, wherein the metadata comprises at least one of user-determined priority, content provider-determined priority, publication date, and request date

11. The system of claim 7, wherein the processor is further capable of changing the status of the at least one content item stored in the device from fixed to replaceable based upon metadata contained in the at least one content item.

12. The system of claim 7, wherein the processor selects the portion of the content item determined to be replaceable based upon metadata contained in the content item.

13. A method for allocating memory of a device, the method comprising:
determining a status of at least one content item stored in the device, the status selected from the group consisting of fixed and replaceable;
determining an amount of memory space needed to store an additional content item to be stored;
determining an amount of memory space in which no content items are stored;
determining an amount of memory space in which all content items determined to be replaceable are stored;
if the amount of memory space needed to store the additional content item is greater than the amount of memory space in which no content items are stored and less than a sum of the amount of memory space in which no content items are stored and the amount of memory space in which all content items determined to be replaceable are stored, then storing at least a portion of the additional content item in a memory location in which at least a portion of a content item determined to be replaceable had been stored.

14. The method of claim 13, further comprising:
storing identification information for the portion of the content item determined to be replaceable;
requesting and receiving the portion of the content item determined to be replaceable when memory space is available to restore the portion of the content item determined to be replaceable.

15. The method of claim 13, further comprising:
changing the status of the at least one content item stored in the device from replaceable to fixed based upon metadata contained in the at least one content item.

16. The method of claim 15, wherein the metadata comprises at least one of user-determined priority, content provider-determined priority, publication date, and request date.

17. The method of claim 13, further comprising:
changing the status of the at least one content item stored in the device from fixed to replaceable based upon metadata contained in the at least one content item.

18. The method of claim 13, wherein the portion of the content item determined to be replaceable is selected based upon metadata contained in the content item.

19. A computer program product for allocating memory of a device, the computer program product comprising at least one computer-readable storage medium having computer-readable program code portions stored therein, the computer-readable program code portions comprising:
a first executable portion capable of determining a status of at least one content item stored in the device, the status selected from the group consisting of fixed and replaceable;
a second executable portion capable of determining an amount of memory space needed to store an additional content item to be stored, an amount of memory space in which no content items are stored, and an amount of memory space in which all content items determined to be replaceable are stored;
a third executable portion capable of determining if the amount of memory space needed to store the additional content item is greater than the amount of memory space in which no content items are stored and less than a sum of the amount of memory space in which no content items are stored and the amount of memory space in which all content items determined to be replaceable are stored and then storing at least a portion of the additional content item in a memory location in which at least a portion of a content item determined to be replaceable had been stored.

20. The computer program product of claim 19, further comprising:
a fourth executable portion capable of storing identification information for the portion of the content item determined to be replaceable;
a fifth executable portion capable of requesting and receiving the portion of the content item determined to be replaceable when memory space is available to restore the portion of the content item determined to be replaceable.

21. The computer program product of claim 19, further comprising:
a fourth executable portion capable of changing the status of the at least one content item stored in the device from replaceable to fixed based upon metadata contained in the at least one content item.

22. The computer program product of claim 21, wherein the metadata comprises at least one of user-determined priority, content provider-determined priority, publication date, and request date.

23. The computer program product of claim 19, further comprising:
a fourth executable portion capable of changing the status of the at least one content item stored in the device from fixed to replaceable based upon metadata contained in the at least one content item.

24. The computer program product of claim 19, wherein the third executable portion selects the portion of the content item determined to be replaceable based upon metadata contained in the content item.
